(19) United States
(12) Patent Application Publication
(10) Pub. No.: US 2008/0279281 A1
(43) Pub. Date: Nov. 13, 2008

(54) Method and System for Compound Conditional Source Coding

(76) Inventors: Stark C. Draper, Newton, MA (US); Emin Martinian, Arlington, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/745,519

(22) Filed: May 8, 2007

(51) Int. Cl. H04B 1/66

(52) U.S. Cl. 375/240.22; 375/E07.124

(57) ABSTRACT

Embodiments of the invention describe a compound conditional source coding method and system for communicating source data over a network. Length-n random uncompressed source data are drawn according to a distribution pₓ(x), and serves as input data to an encoder. A set P of candidate side-information vectors is also input to the encoder. The encoder encodes the source data, utilizing the set of the candidate side-information vectors, to produce an encoded message. The message is transmitted to a decoder. The decoder decodes the received message to produce a source estimate, using selected side-information vector and an index of the selected side-information vector in the set of the candidate side-information vectors.

### FIELD OF THE INVENTION

This invention relates generally to conditional source coding, and more particularly to compound conditional source coding, Slepian-Wolf list decoding, and applications for media coding.

### BACKGROUND OF THE INVENTION

Distributed source coding and predictive or “conditional” source coding are used in a wide range of applications. Examples of applications include temporal video and media compression, sensor networks, secure multimedia coding. See, D. Slept an and J. K. Wolf: “Noiseless coding of correlated information sources,” IEEE Trans. Inform. Theory, 19:471.480, July 1973, and R. M. Gray; “Conditional rate-distortion theory,” Technical report. Stanford Electronics Laboratories. No. 6502-2, 1972,

FIG. 1 shows a block diagram that describes both conventional distributed source coding and conventional conditional source coding. In both scenarios there is a length-n random source sequence x 10 that is compressed into (nR) bits by an encoder 40 and then transmitted over a noiseless rate-constrained channel 20, to a decoder 30. The decoder 30 also receives length-n side-information vector y 50, in which the pair (x, y) is distributed according to p_{xy}(x, y). The distinction between conditional and distributed source coding is in the information available to the encoder 40. In conditional source coding, the side-information vector y 50 is an input to the encoder 40, i.e., switch 60 is closed. In distributed source coding, switch 60 is open, and the encoder 40 cannot use the side-information vector y 50. In distributed source coding, the only information the encoder 40 has about the side-information vector y 50 is that it exists, and that the side-information vector y 50 is statistically related to the source data x 10 according the joint distribution p_{xy}(x, y). We note that there are distributed source codes that work without knowledge of p_{xy}(x, y).

As an example, a video coding is treated as a conditional source coding problem. Because switch 60 is closed, each frame can be predictively encoded based on the previous frames. Video coding can also be approached as a distributed source coding problem, as is discussed in, e.g., A. Aaron, R. Zhang, and B. Girod. “Wyner-Ziv coding of motion video,” in Proc. Asilomar Conf. on Signals, Systems and Comput., Monterey, Calif., November 2002 and R. Puri and K. Ramchandran. PRISM: “A new robust video coding architecture based on distributed compression principles,” in Proc. 40^{th} Allerton Conf. on Commun., Control and Comput., Monticello, Ill., October 2002. As shown in FIG. 1, if the switch 60 is open, the source data x 10 corresponds to the current frame in the video sequence to be encoded, and the decoder side-information vector y 50 corresponds to the already decoded previous frame. Advantage of this approach to video coding include complexity-shifting from encoder to decoder and robustness to packet losses.

Wyner-Ziv video coding is a rate-distortion version of Slepian-Wolf coding. At a high level, a Wyner-Ziv system is a conventional vector quantizer, followed by a Slepian-Wolf encoder and decoder, and followed by post-processing including a joint estimate of the source x based on the decoded vector quantization of the source x and the side-information vector y. Thus, the Slepian-Wolf core is the only distributed aspect of a Wyner-Ziv system.

For a number of applications, e.g., the Wyner-Ziv video coding, it is desired to represent the side-information vector y as a set of possibilities, rather than as predefined information.

### SUMMARY OF THE INVENTION

Embodiments of the invention provide a compound conditional source coding system and method that model a number of media coding scenarios. Distributed source coding methods, while centrally important in robustly addressing the compound nature of these problems, do not by themselves characterize a full range of operational possibilities. The invention demonstrates an encoding technique whose reliability exceeds that of distributed source coding.

Length-n random uncompressed source data are drawn according to a distribution pₓ(x), and serves as input data to an encoder. A set P of candidate side-information vectors is also input to the encoder. The encoder encodes the source data, using the set of the candidate side-information vectors, to produce an encoded message. The message is transmitted to a decoder. The decoder decodes the received message to produce a source estimate, using a selected side-information vector and an index of the selected side-information vector in the set of the candidate side-information vectors.

### BRIEF DESCRIPTION OF THE DRAWINGS

FIG. 1 is a block: diagram of conventional distributed and conditional source coding;

FIG. 2 is a block diagram of a compound conditional source coding system according to embodiments of our invention;

FIG. 3 is a block diagram of a pre-encoding process for the compound conditional source coding according to the embodiments of our invention;

FIG. 4 is a block diagram of an encoding process for the compound conditional source coding according to an embodiment of the invention;

FIG. 5 is a block diagram of a decoding process for the compound conditional source coding according to an embodiment of the invention; and

FIGS. 6A-C are block diagrams of applications which use the compound conditional source coding method according to the embodiments of the invention.

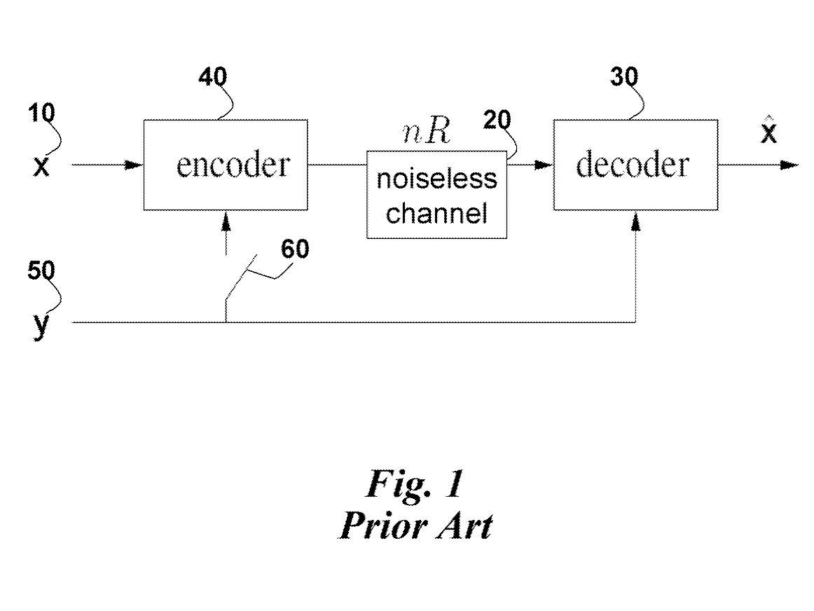

### DETAILED DESCRIPTION OF THE PREFERRED EMBODIMENT

Compound Conditional Source Encoding System

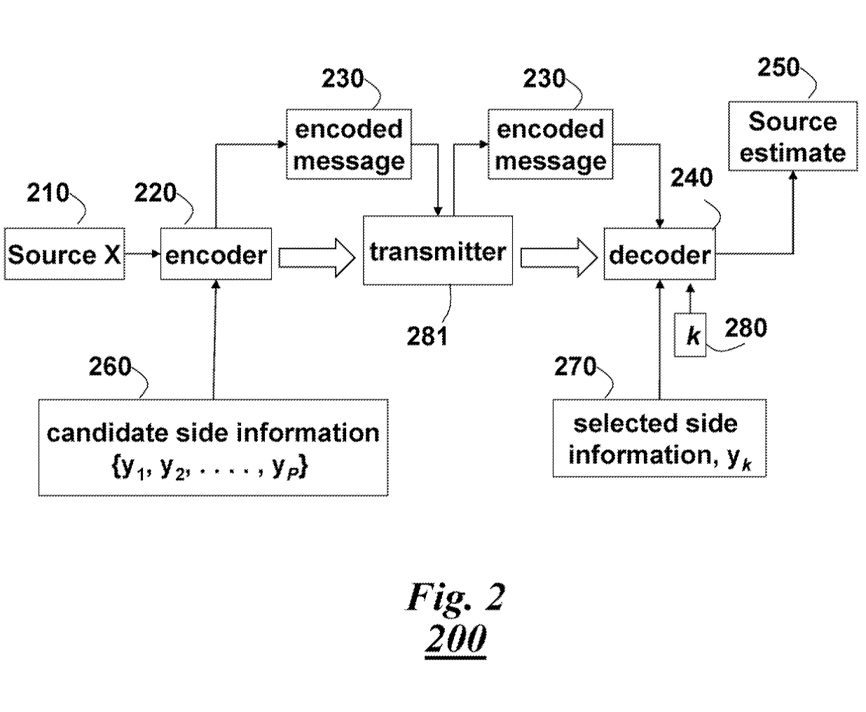

FIG. 2 shows a method and system 200 for compound conditional source coding according to an embodiment of our invention. Length-n random uncompressed source data x 210 are drawn according to a distribution pₓ(x), and serves as input data to an encoder 220. The source x can be any uncompressed data, e.g., video frames, images, text, audio, sensor data, and the like. A set P of candidate side-information vectors {y₁, y₂, . . . , y_{P}} is also input to the encoder 220. The side-information vectors are drawn according to conditional distributions, respectively:

p_{y}_{₁}_{|x}(y₁|x), p_{y}_{₂}_{|x}(y₂|x), . . . p_{yP|x}(y_{P}|x).

Thus, the encoder 220 only knows that the side-information, vector y is one of a certain, small finite, set of the candidate side-information vectors {y₁, y₂, . . . , y_{P}} 260, but does not know which particular the side-information vector is observed at the decoder.

As defined herein, the set of the candidate side-information vectors 260 includes two or more members. The encoder 220 encodes the source x 210, using the set: of the candidate side-information vectors 260, to produce an encoded message 230. The message 230 is sent by a transmitter 281 over a channel to a decoder 240. The decoder 240 decodes the received message 230 to produce a source estimate 250, using selected side-information vector yₖ 270 and an index k 280 of the selected side-information vector 270 in the set of the candidate side-information vectors 260. Our invention does not require a probability distribution on the selection of the index k 280, though such a distribution can be incorporated. The encoder 220 and the decoder 240 both know all the joint distributions, p_{x,y}_{ₚ}(x, yₚ) for all p ε {1, 2, . . . , P}. Furthermore, the decoder 240 knows the index k 280 of the selected candidate side-information vector yₖ 270.

In contrast to compound conditional source coding, in conditional source coding P=1, and in distributed source coding the encoder knows only the side-information vector y that is a member of a typical set of possibilities, hence P˜2^{nH(y|x)}. Because in compound systems the encoder does not know which of the P possibilities is received by the decoder, conditional coding fails.

On the other hand, distributed source coding can operate successfully if the compression rate is chosen large enough. However, because the set of possibilities has been narrowed from an exponential to a sub-exponential number, the encoder 220 is able to operate more efficiently than conventional encoders that use only Slepian-Wolf coding techniques.

Pre-Encoding Process

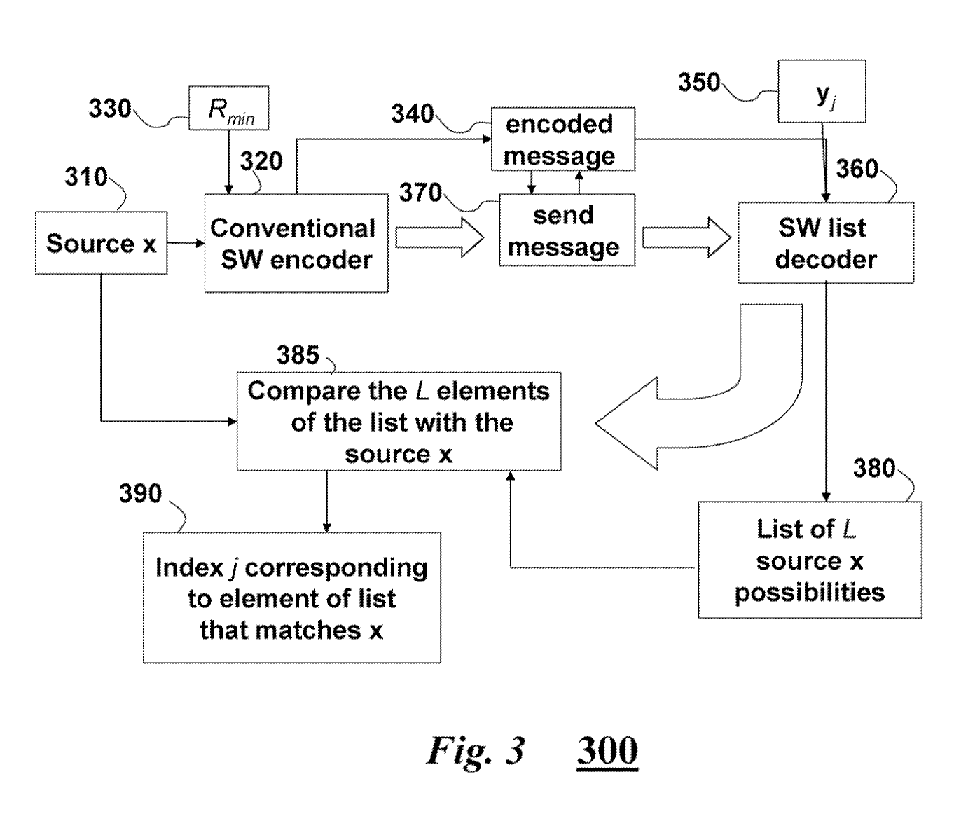

FIG. 3 shows a pre-encoding process 300 according to an embodiment of our invention. The process 300 is repeated for every element of the candidate side-information vectors yⱼ for j ε {1, 2, . . . , P} 350. The source x 310 serves as an input to an encoder 320. Here, the encoder 320 is a conventional encoder, the same as the encoder for Slepian-Wolf distributed source coding. A minimum encoding rate Rₘᵢₙ 330 serves as a parameter for the encoder 320. In one embodiment, the minimum encoding rate Rₘᵢₙ is greater than max j ε {1, 2, . . . P} H(x|yⱼ), where H(x|yⱼ) is a conditional entropy.

The encoder 320 produces an encoded message 340 which is sent 370 to a decoder 360. Here, the decoder 360 is a Slepian-Wolf list decoder. In maximum likelihood decoding, the output of the decoder is the single best-estimate of the source x. In list decoding, the decoder outputs a length-L list of source possibilities 380. The list decoder fails only if the input source x 310 is not on the list. Thus, the list decoder 360 produces the list L(yⱼ) 380 of L possibilities for the source x 310. As for the conventional decoder, the side-information vector yⱼ 350 is also an input to the list decoder 360.

Elements of the list L 380 are compared 385 with the input source x 310. The result of the comparison 385 is a matching index j 390 of the element of the list L 380, which matches the input source x 310.

Encoding

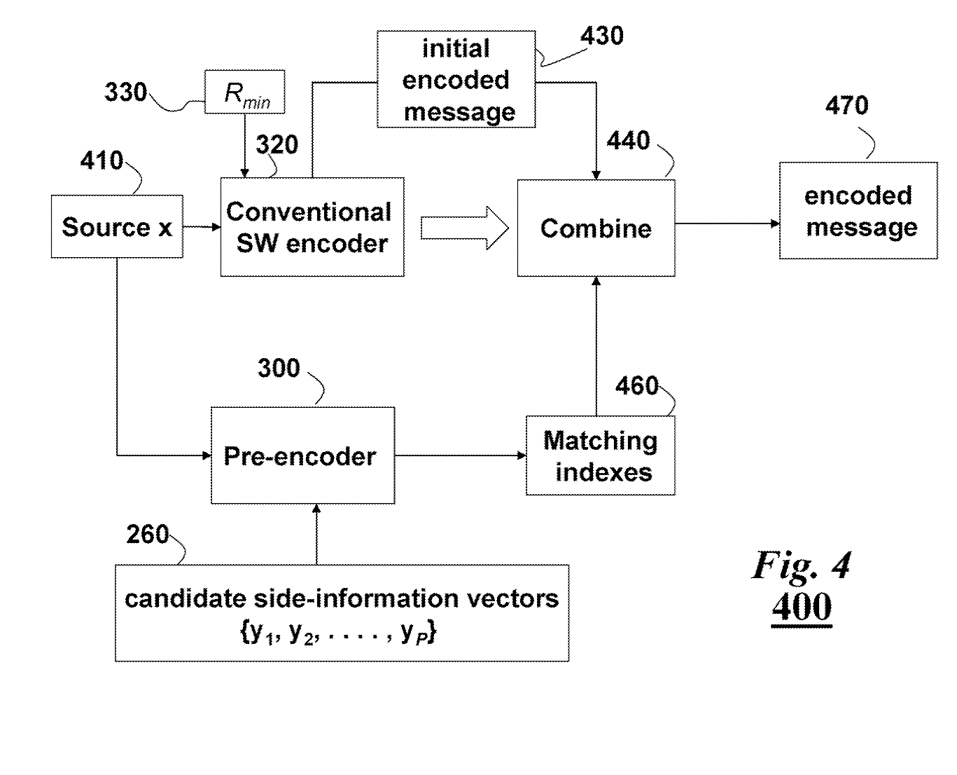

FIG. 4 shows a process 400 that adapts the conventional Slepian-Wolf encoder and the pre-encoding process to give a high-reliability compression system for the compound conditional source coding, according to the embodiments of our invention. We pre-encode 300 the source x 410 to produce the P matching indexes 460. The conventional encoder 320 encodes the source x 410 and produces a Slepian-Wolf initial encoded message 430. The initial encoded message 430, is combined 440 with the matching indexes 460 to produce the encoded message 470.

The encoded message 470 includes additional resolution information, i.e., the matching indexes 460, the result of the pre-encode step 300. These additional resolution information bits identify which entry on each list, i.e., for each of the P possible side-information vectors, is the correct source sequence. As described above, the pre-encode step 300 calculates the matching indexes by list-decoding with each of the P candidate side-information vectors, as shown in FIG. 3. Each list-index can be described with logL bits.

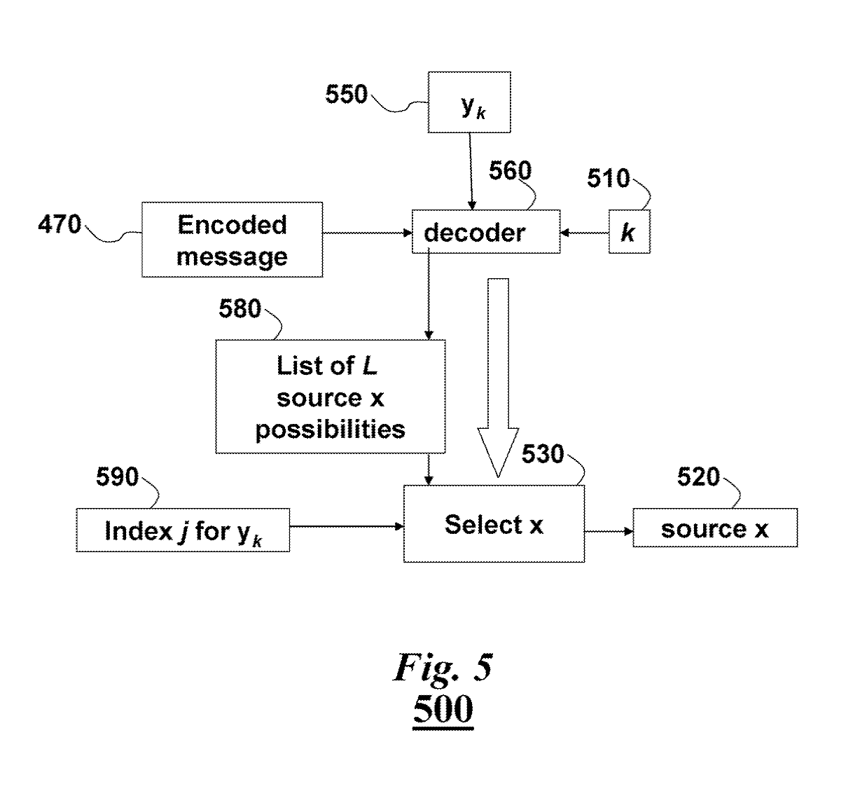

The set of candidate side-information vectors has cardinality P, the total number of resolution bits is P logL. The rate of the resolution information is P log L/n, which decreases to zero as the block length n increases. Thus, asymptotically, the resolution information uses a zero additional rate. The message y 470 is sent to a decoding process 500, see FIG. 5.

Compound Decoding

FIG. 5 shows compound decoding process 500 according to an embodiment of our invention. A received encoded message 470, side-information vector yₖ 550, and the index k of the side-information vector are inputs to the decoder 560. The decoder 560 is the list decoder, and produces a list 580 of L source x possibilities. From the list 580, an element with the matching index j 590 is selected 530. This element is our decoded source x 520.

Analysis

Below, we describe technical analysis results of our embodiments. These include the rate-requirements of compound conditional source coding, achievable error exponents for Slepian-Wolf list decoding, and achievable error exponents of compound conditional source coding. For some embodiments, we state results for the case of memory-less independent and identically distributed (i.i.d.) sources.

Compound Conditional Source Coding Theorem 1

Let

p_{x,y}_{ₚ}(x, yₚ)=Πᵢ₌₁ⁿp_{x, y}_{ₚ}(x, y_{p,i}),

where p_{x, y}_{ₚ}(x, yₚ) is a joint distributions of a length-n source sequence x with side-information vectors yₚ, where p ε {1, 2, . . . P}. The encoder receives the source x and the set of candidate side-information vectors yₚ for all p ε {1, 2, . . . P}. The decoder receives only the selected side-information vector yₖ, where the index k ε {1, 2, . . . , P}. For any ε>0, there exists an n₀>0 such that for all n>n₀ there exists an encoder/decoder pair with Pr[\hat{x}≠x]<ε if

$$R > {max}_{p ∈ \{ 1 , 2 , … , P \}} H ( x \text{\textbar} {y}_{p} ) \qquad ( 1 )$$

In maximum likelihood decoding, the output of the decoder is the single best-estimate of the source sequence. In list decoding, the decoder outputs a length-L list of possible sources. The list decoder fails only if the true source sequence is not on the list, see P. Elias “List decoding for noisy channels,” Technical Report MIT Research Lab, of Electronics Tech. Report 335, Mass. Instit. Tech., 1957.

We derive the following list-coding result for distributed Slepian-Wolf source coding.

List-Decoding for Slepian-Wolf Systems Theorem 2

Let p_{x,y}(x, y) be the joint distribution of a pair of length-n random sequences (x, y), where x is the source input to the encoder and y is the decoder side-information vector. There exists a rate-R encoder/list-decoder pair, where the list L(y) is of size |L(y)|=L, such that the average probability of a list decoding error is bounded for any choice of ρ, 0≦ρ≦L as

$$Pr [ x ∉ L ( y ) ] \leq {2}^{- npR} {\sum }_{y} {( {\sum }_{x} {{p}_{x , y} ( x , y )}^{\frac{1}{1 + p}} )}^{1 + p} . \qquad ( 2 )$$

In the special case of an i.i.d source distribution

p_{x,y}(x, y)=Πᵢ₌₁ⁿ p_{x,y}(xᵢ, yᵢ),

and maximizing over the free parameter 0≦ρ≦L, we obtain the following error exponent.

IID Corollary 1

For i.i.d. sources there exists a rate-R distributed source coding list-encoder/decoder-pair such that Pr[x ∉ L(y)]≦2^{-nE} for all E≦E_{SW,list}(p_{x,y,} R, L) where E_{SW,list}(p_{x,y,} R, L)=

$${E}_{SW , list} ( {p}_{x , y} , R , L ) {max}_{0 \leq ρ \leq L} ρ R - log {\sum }_{y} {( {\sum }_{x} {{p}_{x , y} ( x , y )}^{\frac{1}{1 + p}} )}^{1 + p} . \qquad ( 3 )$$

The following corollary states that the error exponent of compound conditional source coding is at least as large as the list-decoding error exponent of the distributed source coding problem under the selected joint distribution p_{x,y}_{ₖ}

Error Exponent of Compound Conditional Source Coding Corollary 2

Consider the compound conditional source coding problem of Theorem 1. The index for the decoder side-information vector is k, where the index k ε {1, 2, . . . P}. Then

$$- \frac{log Pr [ \hat{x} \neq x ]}{n} \geq {E}_{SW , list} ( {p}_{x , {y}_{k}} , R , L ) \qquad ( 4 )$$

In maximum likelihood decoding for conventional Slepian-Wolf decoding, 0≦p≦1, while in length-L list decoding, 0≦p≦L. This additional freedom translates into a large increase in the exponent at higher rates. This is the same effect as when list decoding is used in channel coding.

### EFFECT OF THE INVENTION

Certain media coding application, where distributed source coding techniques are used, can be stated more exactly as compound conditional problems. This insight can lead to improved system performance, as we demonstrate for error exponents.

Examples of Compound Conditional Source Coding Applications

Multiview Coding

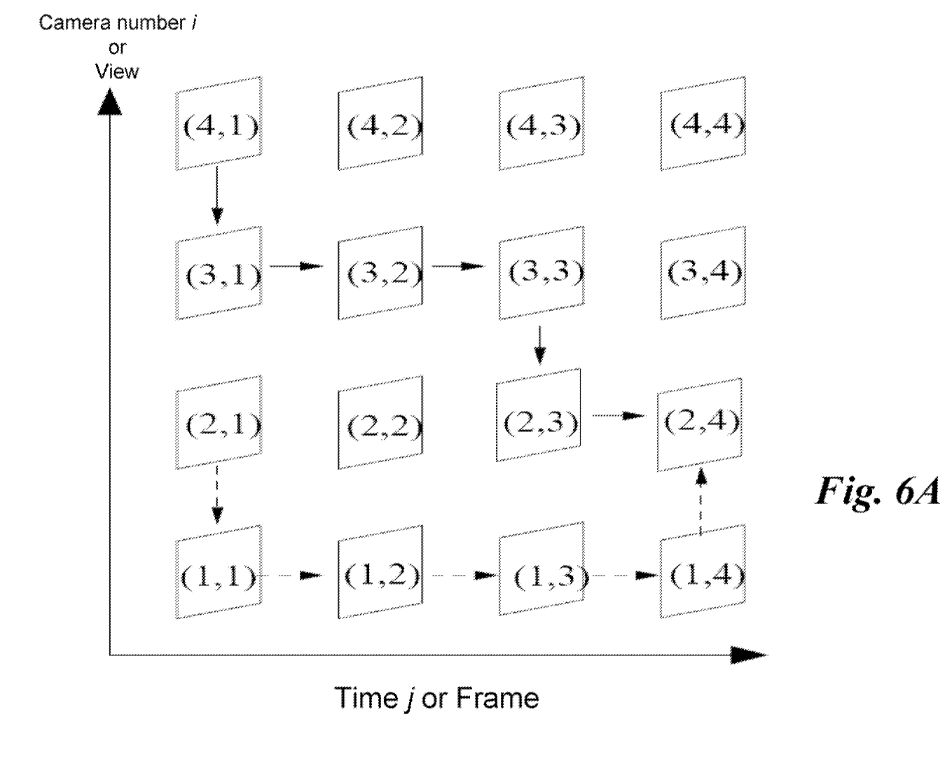

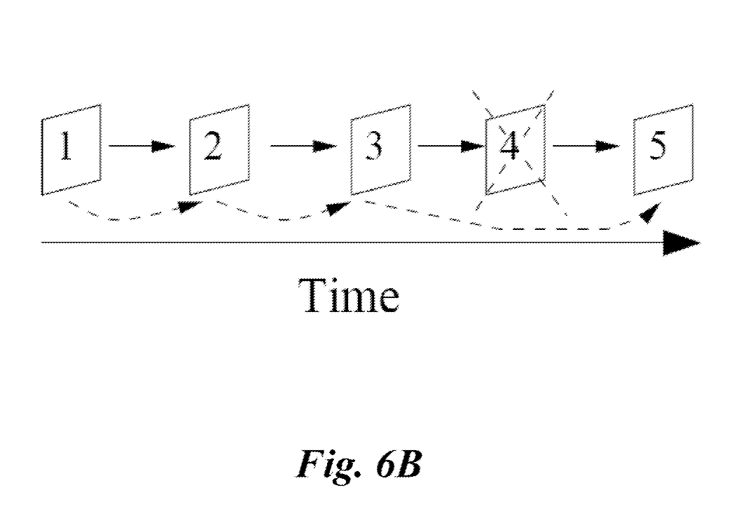

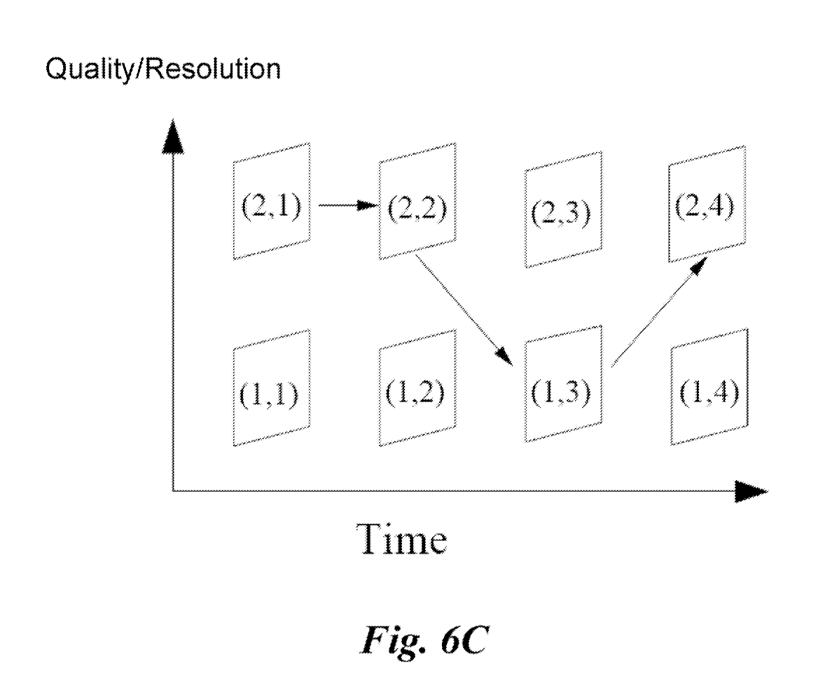

In multiview video/image coding, images are acquired of a scene by multiple cameras at each time instant t. For the purpose of this description, each time instant is associated with a frame. For example, in FIG. 6A i represents the camera number or view, and j the time instant j of a particular image or frame. Typically, each, camera has a different view of the scene. Conventional predictive coding does not allow random access during the decoding, i.e., decoding in any arbitrary order, while intra-coding has poor compression efficiency. In contrast, Wyner-Ziv coding enables random access, e.g., decoding in the order illustrated by either the solid or the dashed lines, while also providing higher compression efficiency than independent intra-coding of each frame. When Wyner-Ziv techniques are used, this is an example of compound conditional source coding.

The possible side-information vector sequences for the encoder is predetermined. For example, the prediction reference frames for frame (2, 4) can either be frame (1, 4) or frame (2, 3), depending on the desired decoding order.

Robust Video Coding

Wyner-Ziv coding of video to reduce error propagation is used when video frames are transmitted over a lossy channel, see FIG. 6B. For example, by using Wyner-Ziv coding at the appropriate bit rate, frame 5 can be decoded by using either frame 4 as a predictive reference frame if frame 4 is received without error, or by using frame 3 as a predictive reference frame if frame 4 is lost.

This is another example of a compound conditional source coding application because the encoder knows in advance the possible side-information vector (frame 4 or frame 3 or frame 2 or frame 1) that the decoder might use in decoding frame 5.

Stream Switching for Multiresolution Video Coding

A key issue in streaming a video is that the network bandwidth can vary over time. Some applications use Wyner-Ziv video coding to allow the transmitter to vary the bit-rate/resolution/quality of the video stream dynamically. Enabling the decoder to “switch” from one resolution to another is complicated by the fact that the decoder may not have the prediction reference frames from the other video stream.

As shown in FIG. 6C for example, a decoder wishes to switch from high resolution to low resolution at time/frame 3. The decoder may not have the previous prediction reference frames for the new resolution. Various methods of addressing this issue include: forcing motion vectors for each resolution to be the same, only allowing resolution switches at intra “I” frames, or using SP/SI frames. An alternative is to encode error residuals or texture information using Wyner-Ziv coding to allow more graceful resolution switching. Once again, this is an example of compound conditional source coding problem because the encoder knows the possible resolutions, which can serve as side-information vector beforehand.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for communicating source data over a network, the method comprising the steps of:
providing source data to an encoder;
providing a set of candidate side-information vectors to the encoder, wherein the set of candidate side-information vectors has at least two vectors;
encoding the source data by the encoder to produce an encoded message, wherein the encoder utilizes the set of candidate side-information vectors;
transmitting the encoded message over a network to a decoder;
providing the decoder with a selected side-information vector from the set of candidate side-information vectors, and an index of the selected side-information vector in set of the candidate side-information vectors; and
decoding the encoded message to produce the source data.

2. The method of claim 1, wherein the encoding step further comprising:
determining, for each element of the set of candidate side-information vectors, a matching index; and
including the matching indexes in the encoded message.

3. The method of claim 1, wherein the source data are drawn according to a statistical distribution.

4. The method of claim 1, wherein the source data are uncompressed data.

5. The method of claim 1, wherein the set of the candidate side-information vectors is drawn according to a conditional distribution.

6. The method of claim 1, further comprising:
providing to the encoder and to the decoder a joint distribution of the source data and the set of the candidate side-information vectors.

7. The method of claim 2, wherein the determining step further comprising:
specifying a minimum encoding rate, wherein the minimum encoding rate is greater than maxₚH(x|yₚ), where H(x|yₚ) is a conditional entropy, and P is the set of the candidate side-information vectors.

8. The method of claim 2, wherein the decoding is a list decoding, and the decoding step produces a list of possible source data, and the decoding further comprising:
selecting the source data from the list of possible source data, according to the matching indexes.

9. The method of claim 1, wherein the source data are images acquired of a scene by multiple cameras at each time instant, and the set of candidate side-information vectors includes previously decoded images.

10. A system for communicating source data over a network, the system comprising:
an encoder, the encoder configured to accept as an input source data and a set of candidate side-information vectors, wherein the set of candidate side-information vectors has at least two vectors, and to produce an encoded message;
a transmitter, for transmitting the encoded message over a network; and
a decoder, the decoder configured to accept as an input the encoded message transmitted over the network, a selected side-information vector from the set of candidate side-information vectors, and an index of the selected side-information vector in set of the candidate side-information vectors, to produce the source data.
